(19) United States
(12) Patent Application Publication
(10) Pub. No.: US 2020/0047411 A1
(43) Pub. Date: Feb. 13, 2020

(54) A GANTRY-TYPE THREE DIMENSIONAL PRINTING APPARATUS FOR PRINTING A THREE DIMENSIONAL WORK PIECE IN A LAYER WISE MANNER

(71) Applicant: Blackbelt Holding B.V., Belfeld (NL)

(72) Inventor: Stephan SCHÜRMANN, Belfeld (NL)

(21) Appl. No.: 16/605,287

(22) PCT Filed: Apr. 16, 2018
(86) PCT No.: PCT/NL2018/050236

§ 371 Date: Oct. 15, 2019

(30) Foreign Application Priority Data
Apr. 18, 2017 (NL) 2018728

(51) Int. Cl. B29C 64/245; B29C 64/25; B29C 64/209; B29C 64/232; B29C 64/236; B29C 64/379; B29C 64/295

(52) U.S. Cl. CPC B29C 64/245; B29C 64/25; B29C 64/209; B33Y 30/00; B29C 64/236; B29C 64/379; B29C 64/295; B29C 64/232

(57) ABSTRACT

The invention relates to a gantry-type three dimensional printing apparatus for printing a three dimensional work piece in a layer wise manner using a building material, said apparatus comprising at least: a frame with an XYZ-gantry; a printing head unit coupled to said XYZ-gantry; a building material supply unit for feeding building material to said printing head unit; and a support platform on which said three dimensional work piece is being printed in layers, said support platform being part of said XYZ-gantry and is movable in the Z-direction.

### FIELD OF THE INVENTION

The invention relates to a gantry-type three dimensional printing apparatus for printing a three dimensional work piece in a layer wise manner using a building material, said apparatus comprising at least: a frame with an XYZ-gantry; a printing head unit coupled to said XYZ-gantry; a building material supply unit for feeding building material to said printing head unit; and a support platform on which said three dimensional work piece is being printed in layers, said support platform being part of said XYZ-gantry and is movable in the Z-direction.

### BACKGROUND OF THE INVENTION

Gantry-type three dimensional printing apparatuses for printing a three dimensional work piece in a layer wise manner have been developed over the recent years as a fast, and relative inexpensive technology to create three dimensional work pieces, which work pieces otherwise would have required the implementation of expensive and time consuming molding and casting techniques.

During three-dimensional printing successive layers of powder or molten plastic are deposited on a support platform, wherein said successive layers adhere or bind to themselves. The sequential or layer wise manner of depositing molten building material in a malleable state onto each other, a three-dimensional work piece can be formed. With a proper control of the XYZ-gantry the printing head unit can be manipulated within the working area defined by the XYZ-gantry and three dimensional work pieces having complex and even interlocking geometries can be manufactured.

Recent developments in gantry-type three dimensional printing apparatuses have resulted in the development of affordable, small size printing unit, which can be used at home or schools. With the development of sophisticated designing programming tools three dimensional work pieces can be made, which were otherwise extremely difficult to be fabricated through traditional means, if not impossible.

A drawback, however, of the known XYZ-gantry-type three dimensional printing apparatuses is the limited working space defined by the XYZ-gantry and as such the limited freedom of manipulation of the printing head unit within said working space and subsequent the limited dimensional size of the work pieces thus printed. In particular printing work pieces with a considerable longitudinal dimension suffer from all types of disturbances, such as material instability or vibrations, which will adversely affect the final quality of the work piece when depositing molten building material in a malleable state in subsequent layers on each other.

### DESCRIPTION OF THE INVENTION

The invention aims to provide a solution for the above identified problem, allowing the printing in a layer wise manner of three dimensional work pieces having more complex or detailed features as well as work piece of considerable size or length.

According to the invention, the printing head unit is movable within a XY-plane being inclined relative to the Z-direction and wherein the support platform is composed as an endless conveyor belt oriented parallel with the horizontal.

In an example of the gantry-type three dimensional printing apparatus the conveyor belt is made from a fiber composite cloth, and more in particular said fiber composite cloth is impregnated with an epoxy resin. Herewith a stable support area is obtained, which not only stabilizes the three dimensional work piece during its layer wise built up, but moreover a good heat dissipation is obtained thus preventing printing errors due to collapsing or slumping in of the building material being printed.

In another example the conveyor belt is made from a metal sheet, in particular from a metal alloy with the mechanical properties of 1) low thermal expansion rate, to provide the belt being flat, when heated up or hot material is being placed onto; and/or 2) having a high stiffness, in order to provide accurate positioning and rigid holding of the workpiece; to prevent it from un-controlled movements during the print process, and/or 3) a temperature resistance, which is higher than the building material temperature, during the print process.

In order to avoid unwanted displacement on the support platform of the three dimensional work piece during its layer wise built up the conveyor belt is provided with a non-permanent adhesive coating.

In another example said support platform furthermore comprises suction elements for creating a vacuum or under pressure between the support platform and the three dimensional work piece to be printed. Herewith also unwanted displacement on the support platform of the three dimensional work piece during its layer wise built up is avoided.

In addition in order to avoid unwanted deformation, such as cracks, ruptures or deformations of the three dimensional work piece due to an uncontrolled cooling down of the building material being printed during its layer wise built up, but also to increase the adhesion between the product and the conveyor belt, and to prevent it from detaching before the end of the conveyor belt, said support platform furthermore comprises heating elements disposed in the Z-direction for heating the endless conveyor belt.

In yet another example said support platform furthermore comprises cooling elements disposed in the Z-direction for cooling down the endless conveyor belt. Herewith it is possible to manufacture three dimensional work pieces having small dimensions in fast and large quantities, which smaller work pieces as such require a fast cooling down allowing a quick removal from the support platform for further after processing, such as packaging and transport.

Said cooling means may comprise one or more cooling fans being disposed above the support platform and being directed towards the product being printed on the support platform. As such a cooling flow of air is created and directed towards the product being printed.

In yet another example of the gantry-type three dimensional printing apparatus setting means are provided for setting the angle of inclination of the XY-plane relative to the Z-direction. Herewith a more versatile apparatus is obtained capable of printing three dimensional work pieces in a layer wise manner with a variety of cross sectional geometries (in the XY-plane) and in theory infinite length (in Z-direction)

In another example the printing head unit comprises a nozzle having a cone configuration, with the nozzle outlet positioned at the apex of the cone. In particular the apex of the cone has a vertex angle ψ, where ½ψ(γ)<maximum angle β of inclination of the XY-plane relative to the Z-direction. As such the printing head can be positioned more closely towards the support platform without the risk of touching the support platform or the three dimensional work piece. Furthermore as herewith the printing head can be accurately positioned in close proximity to the three dimensional work piece to be printed, more complex or detailed features of the three dimensional work piece can be printed.

### BRIEF DESCRIPTION OF THE DRAWINGS

The invention will now be described in more details in reference to the accompanying drawings, which drawings show in:

FIG. 1 an example of a gantry-type three dimensional printing apparatus according to the invention;

FIG. 2 a detail of the gantry-type three dimensional printing apparatus of FIG. 1;

FIG. 3 a schematic example of the gantry-type three dimensional printing apparatus of FIG. 1;

FIG. 4 a schematic example of the gantry-type three dimensional printing apparatus of FIG. 1;

FIG. 5 a detail example of a printing head unit for use in a gantry-type three dimensional printing apparatus according to the invention;

FIG. 6 and FIG. 7 two methods according to the invention for printing a three dimensional work piece.

### DETAILED DESCRIPTION OF THE INVENTION

For a better understanding of the invention like parts in the drawings are to be denoted with like reference numerals.

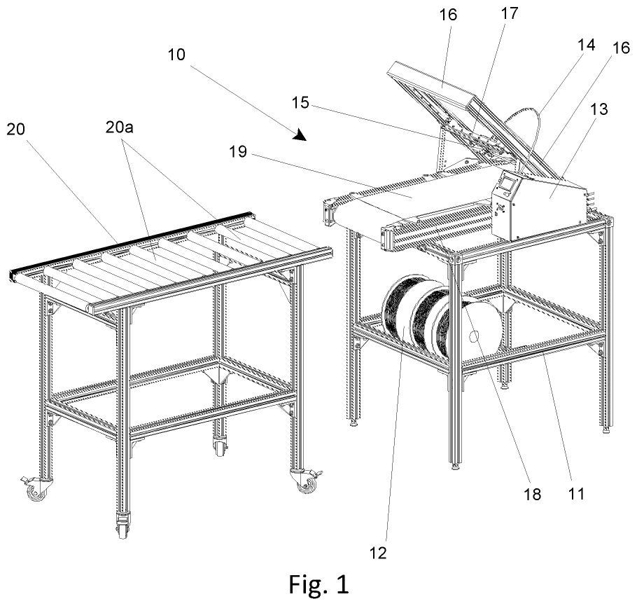

FIG. 1 shows an non-limiting example of a gantry-type three dimensional printing apparatus according to the invention. The gantry-type three dimensional printing apparatus is indicated with reference numeral 10 and in this embodiment consists of a frame 11 which is preferably open and consists of an arrangement of bars interconnected with each other and positioned on pedestals on the ground surface. Within the frame 11 one or more supply spools 12 are accommodated, which supply spools contain an elongated filament of building material, which filament has a significant length of several hundreds of meters which is wound in windings around the spool 12. The elongated filament of building material is preferably a plastic or a metal which is feed from the supply spool 12 towards a supply unit/control unit 13 which controls the supply of the building material towards the printing head 15.

In this example, the printing head 15 of the gantry-type three dimensional printing apparatus 10 is accommodated in an XY-gantry composed of a square or rectangular frame composed of several elongated frame bars 16 which are joined together to form a square or rectangular gantry frame. The printing head 15 is mounted to a further frame bar 17 which is accommodated between two opposite frame bars 16 in a movable manner. Hereto, both ends of the X-frame bar 17 are movable accommodated in suitable guides 16a present in the two opposite Y-frame bars 16 allowing the X-frame bar 17 to be displaced by suitable (not shown) drive means between both opposite Y-frame bars 16 and within the plane formed by the square or rectangular XY-gantry formed by said frame bars 16.

Similarly, the printing head 15 is movable accommodated along the X-frame bar 17 allowing a displacement of the printing head 15 by suitable (not shown) drive means along the X-frame bar 17 within the plane formed by the square or rectangular formed XY-gantry consisting of the frame bars 16.

The movement of the printing head 15 along the X-frame bar 17 is denoted as a movement in the X-direction whereas the displacement of the X-frame bar 17 between the two opposite Y-frame bars 16 along the guides 16a present in said Y-frame bars 16 is denoted as a movement along the Y-direction. As such, the assembly of the square or rectangular frame of Y-frame bars 16 and the X-frame bar 17 together with the printing head 15 is commonly denoted as an XY-gantry.

Reference numeral 14 denotes a supply line formed as a hollow guide tube for supplying the elongated wire of building material (plastic or metal) from the supply spool 12 stored in the open frame 11 via the building material supply/control unit 13 towards the printing head 15. The supply line 14 is therefore connected to the printing head 15 as well as to the supply/control unit 13. The supply/control unit 13 will take off the elongated building material wire from the spool 12 and will feed it through the supply line 14 towards the printing head 15.

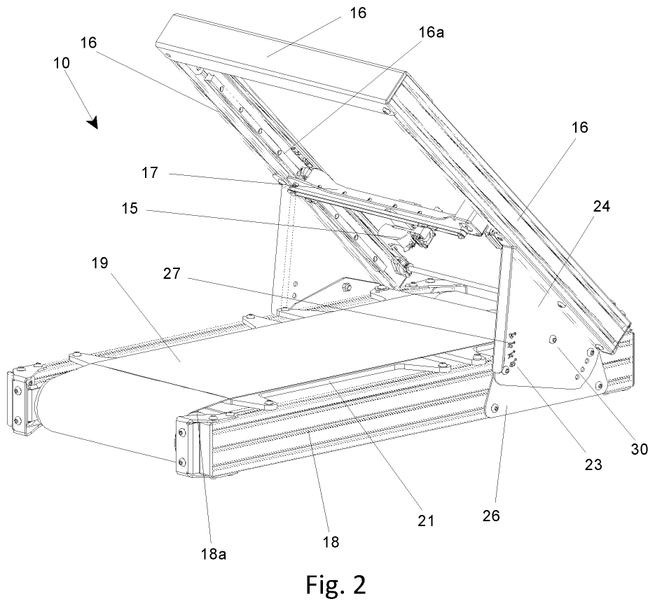

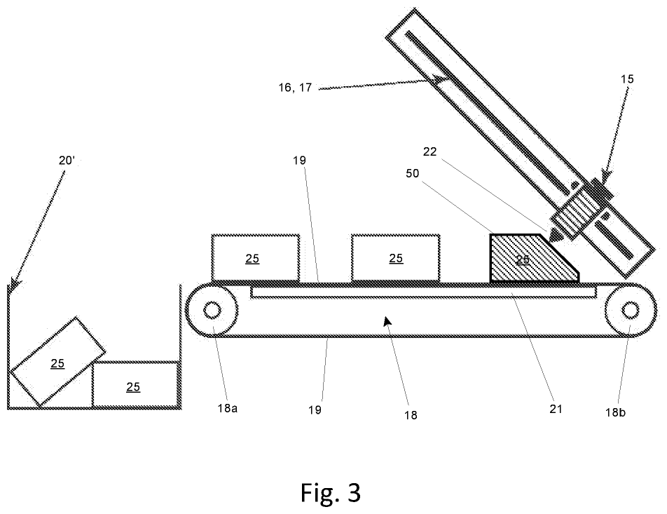

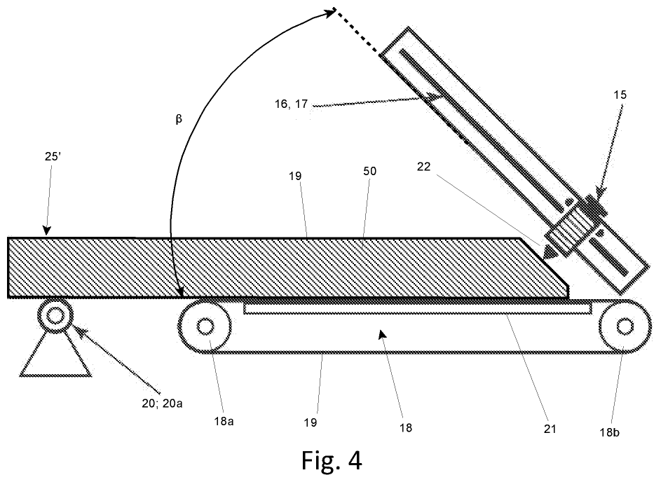

Reference numeral 18 depicts a support platform which forms the Z-part of the XYZ-gantry of the gantry-type three dimensional printing apparatus 10. The support platform 18 is composed of a first conveyer roller 18a and a second conveyor roller 18b (see FIGS. 2-3-4) which are positioned at some distance from each other and which are accommodated within the support platform 18. The two first and second conveyor rollers 18a-18b serve to accommodate an endless conveyer belt 19, which endless conveyor belt 19 in turn functions as the supporting surface on which a three dimensional work piece 25-25′ (see FIGS. 3 and 4) is to be constructed by means of a layer wise printing technique. This is depicted in FIGS. 3 and 4 by means of the layer-like shading of the work pieces 25-25′, illustrating the several subsequent layers 50 being printed.

The endless conveyor belt 19 can be manufactured from a metal sheet, in particular aluminum, which end edges are welded together in order to provide a seam in the endless conveyor belt. However, in another more preferred embodiment the endless conveyor belt 19 is manufactured from a fiber composite cloth. The use of a fiber composite cloth has the advantage over the use of a metal as an endless conveyor belt made from a fiber composite cloth can be obtained without a seam, which seam usually disturbs the evenness of the surface of the endless conveyor belt on which a three dimensional work piece 25-25′ is to be printed in a layer wise manner.

More in particular, the endless conveyor belt made from said fiber composite cloth is impregnated with a thermoset polymer matrix resin, such as an epoxy resin. Herewith, a more stable support area with an improved evenness is obtained which not only stabilizes the three dimensional work piece 25-25′ during its layer wise built up printing (in layers 50). Furthermore, during the layer wise printing technique, the building material (the elongated plastic filament from supply spool 12) is being heated by the printing head and ejected from a printing nozzle 15a of the printing head in a hot and molten (malleable) stage.

In order to avoid dripping or collapsing of the three dimensional work piece 25-25′ during its layer wise print manufacturing in a malleable state, the heat from the molten printed building material needs to be removed quickly in order to avoid dripping or collapsing. To this end, the fiber composite cloth being impregnated with a thermoset polymer matrix resin also serves for a good heat dissipation thus preventing printing errors due to collapsing, dripping or slumping in of the building material/work piece 25-25′ being printed.

In a further example of the three dimensional printing apparatus according to the invention, the support platform 18 can be provided with additional heating means, suction means or cooling means which are positioned directly underneath the endless conveyor belt 19 and which are denoted with reference numeral 21 in FIGS. 2-3-4.

In case reference numeral 21 denotes heating means directly positioned beneath the endless conveyor belt 19, the heating means 21 are arranged in maintaining the endless conveyor belt 19 of the support frame 18 at a predetermined (desired) temperature and as such the work piece 25-25′ to be printed is also kept at a certain temperature and herewith an undesired fast cooling down of the work piece 25-25′ is prevented. This is in particular beneficial in case of printing a work piece 25′ having a considerable length in the Z-direction as depicted in FIG. 4. By keeping the endless conveyor belt 19 at a desired higher temperature, an uncontrolled cooling down of the building material being printed is avoided and herewith it is prevented that in the long structure of the work piece 25′ cracks or otherwise deforms such as bending due to a too fast cooling down of the printed building material is avoided.

In the example wherein the reference numeral 21 is embodied as a suction means positioned beneath the endless conveyor belt 19, the suction means 21 provide an additional stabilization force as the suction force (generate by means of an under pressure or vacuum generated) applied by the suction means 21 and extending its suction influence guarantees a good, firm and stable positioning of the work piece 25-25′ to the support platform 18-19.

In yet another embodiment, reference numeral 21 can be embodied as cooling means which will bring the endless conveyor belt 19 at a temperature which is (significantly) lower than the ambient temperature level and as such will induce a forced cooling down of the work piece 25-25′ to be printed. This can be beneficial in case that the work piece 25-25′ is relatively small in terms of its dimensions and is to be printed in large numbers on the endless conveyor belt. By an accelerated (or forced) cooling down of the building material being printed by the printing head 15 onto the cooled endless conveyor belt 19 the resulting work piece 25 can be quickly removed from the endless conveyor belt 19 for further handling, such as after processing, packaging and transport.

In another example the cooling means are disposed above the support platform and comprise one or more cooling fans being disposed above the support platform and being directed towards the product 25-25′ being printed on the support platform.

Reference numeral 20 denotes an additional support unit being part or cooperating with the support platform 18 of the printing apparatus 10. The support unit 20 consists of an spatial frame incorporating support rollers 20a, which support rollers 20a form an extension of the support surface formed by the endless conveyor belt 19 of the support platform 18. Herewith three dimensional work pieces 25′ having considerable length in the Z-direction (see FIG. 4), which length or Z-dimension is much longer than the Z-dimension of a prior art cubic XYZ-gantry-type three dimensional printing apparatus, can be manufactured more easily.

Advantageously, the gantry-type three dimensional printing machine is constructed in such manner that the XY-gantry 16-17 forms an XY-plane which is inclined relative to the Z-direction thereof. As seen in FIGS. 1-2-3-4, the support platform 18 on which the three dimensional work piece 25-25′ is to be printed in layers 50 is considered being part of the XYZ-gantry of the three dimensional printing apparatus together with the XY-gantry formed by the X-frame bar 17, the Y-frame bars 16 and the printing head 15 mounted on the X-frame bar 17. Furthermore, the support platform 18 is movable in the Z-direction by virtue of the endless conveyor belt 19 being part of said support platform 18.

The inclined configuration of the XY-gantry formed by the frame bar 17 and the square or rectangular frame consisting of the Y-frame bars 16 allows for the printing head 15 to be displaced in an XY-plane (constituted by the square or rectangular frame of the Y-frame bars 16) which XY-plane is inclined relative to the plane formed by the endless conveyor belt 19, which belt 19 extends in the Z-direction of the XYZ-gantry.

With this configuration it is possible, as shown in FIG. 3, to print in a continuous sequence multiple work pieces 25 which are transported over the endless conveyor belt 19 in the Z-direction towards a support or collection unit 20′ which is positioned at the exit site of the support platform 18 near the first conveyor roller 18a.

In another example of the gantry-type three dimensional printing apparatus, a three dimensional work piece 25′ can be printed in a layer wise manner as shown in FIG. 4, which work piece 25′ has a longitudinal dimension seen in the Z-direction which longitudinal dimension is significantly larger than the Z-direction of a prior art cubic shaped gantry-type three dimensional printing apparatus. As such, long work pieces 25′ can be manufactured, such as products which normally only could have been produced using a die casting method or using a milling technique wherein a bar is milled into its end product.

Preferably, the inclination between the XY-gantry 16-17 and the Z-direction formed by the support platform 18 can be set using setting means 23. In this embodiment, the setting means comprise a number of holes drilled in a support flange 24 of the XY-gantry 16-17 and in a support flange 26 of the support platform 18 which holes, once they coincide, can be locked together by inserting a setting pin 27 in the coinciding holes. In another embodiment, the process of changing the angle can also be done automatically by using an electrical mechanism. In yet another embodiment, the angle cannot be adjusted, so that it is always the same. It is noted that the XY-gantry 16-17 can hinge relative to the support platform 18 around a pivot point 30. As such, the angle of inclination between the XY-gantry 16-17 and the Z-direction of the gantry formed by the support platform 18 can be set between a sharp angle between 1° and 89°, dependent on the work piece geometry, with a preferred angle range between 15° and 50°. Also a non-adjustable, fixed angle is possible, like e.g. 45° or a series of fixed angles such as 45°, 35°, 25° and 15°.

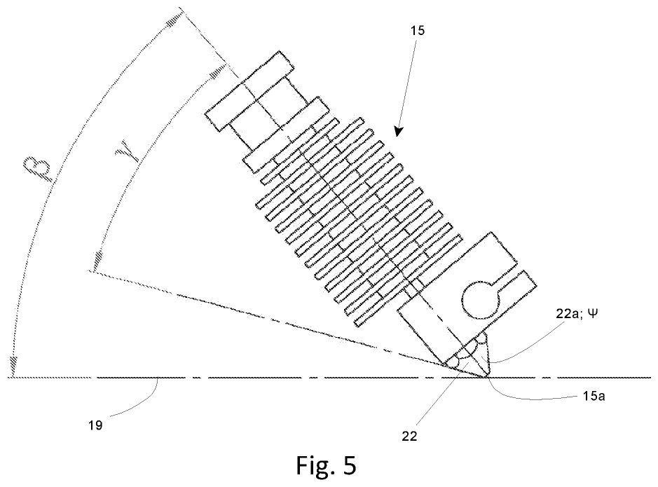

FIG. 5 depicts a detailed embodiment of a printing head 15 for using the XYZ-gantry-type three dimensional printing apparatus 10 according to the invention. As shown in FIG. 5, the printing head 15 exhibits an inclined orientation relative to the endless conveyor belt 19 on which the work piece 25-25′ is to be printed. The printing head 15 comprises a printing nozzle 15a through which the building material is ejected in a molten, malleable manner, being molten plastics or other types of paste-like materials like food, concrete or biotechnical materials. Those past-like materials can be stored in a syringe that is being mounted right behind the printing head (15) and deposited on the endless conveyor belt 19 in accordance with the printing parameters processed by the supply/control unit 13 which controls the printing head 15 when printing the three dimensional work piece 25.

In order to allow the printing head 15, and in particular the printing nozzle 15a to be positioned more closely towards the support platform 18/the endless conveyor belt 19 without the risk of touching the support platform or the endless conveyor belt or the work piece to be printed in a layer wise manner, the printing head unit 15 and in particular the printing nozzle 15a exhibits a cone configuration with the nozzle outlet 15a positioned at the apex of the cone 22. In particular, the apex of the cone has a vertex angle ψ, and half of the vertex angle LP, denoted with γ in FIG. 5, is smaller than the maximum angle β of inclination of the printing head 15 and the XY-plane respectively, relative to the Z-direction formed by the plane of the support platform 18 (the endless conveyor belt 19).

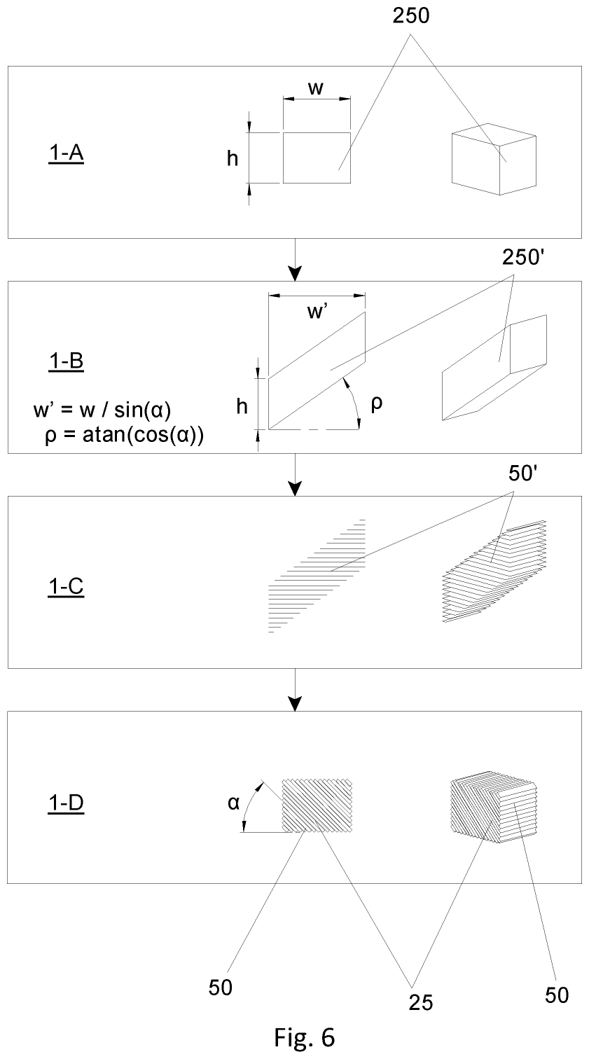

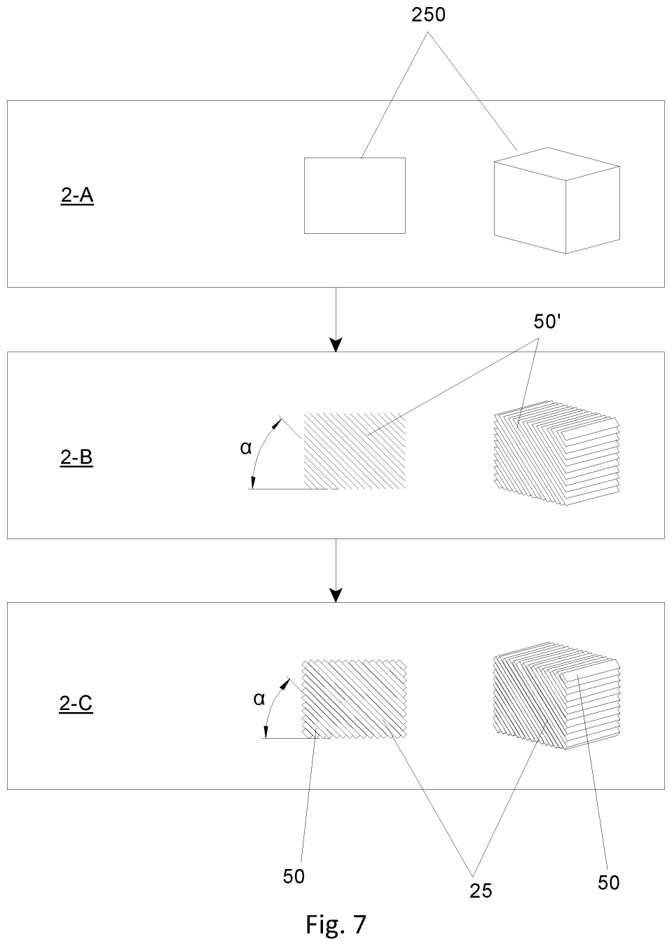

FIGS. 6 and 7 discloses two methods according to the invention for printing a three dimensional work piece 25 using the gantry-type three dimensional printing apparatus 10 according to the invention.

A first implementation of the method for printing a three dimensional work piece using the gantry-type three dimensional printing apparatus 10 according to the invention is depicted in FIG. 6. With this method in a first method step 1-A a computer model of an imaginary three dimensional work piece 250 (here depicted as a cube) with a height h and a width w) is loaded in the control unit 13 of the gantry-type three dimensional printing apparatus 10.

In a second step 1-B the imaginary three dimensional work piece 250 is deformed over an angle ρ such that the height h remains the same but that the width w of the imaginary three dimensional work piece 250 is transformed to a transformation width w′. The transformation angle ρ corresponds with a tan(cos (α)) and the transformation width w′ equals w/sinus (α), with α being the inclination angle under which the gantry-type three dimensional printing apparatus will be printing the subsequent printing layers 50. In particular the angle α corresponds with the inclination between the XY-gantry 16-17 and the Z-direction formed by the support platform 18.

In a next step 1-C the transformed imaginary three dimensional work piece 250′ is subdivided in a series of subsequent imaginary printing layers 50′. The printing data corresponding with said subsequent imaginary printing layers 50′ are used by the control unit to control the printing head 15 of the gantry-type three dimensional printing apparatus 10 to print the three dimensional work piece 25 in a layer wise manner wherein each layer is printed at an inclination angle α.

In yet another embodiment of the method for generating a three dimensional printing model of a three dimensional work piece 25 to be printed with a gantry-type three dimensional printing apparatus 10 according to the invention is depicted in FIG. 7. Also in a first step 2-A the imaginary model 250 of a three dimensional work piece 25 is loaded into the control unit 13 of the gantry-type three dimensional printing apparatus 10.

In method step 2-B the imaginary three dimensional work piece 250 is sliced under an angle α creating a sequence of multiple imaginary slices 50′ which imaginary printing slices 50′ are processed by the control unit 13 in order to control the printing head 15 in such manner that the actual three dimensional work piece 25 is built-up in a layer wise manner under an inclination angle α as defined by the method according to the invention.

### LIST OF REFERENCE NUMERALS

10 gantry-type three dimensional printing apparatus
   11 frame
12 supply spool of building material
13 building material supply unit/control unit
14 supply line for building material towards printing head
15 printing head
15a material printing nozzle of printing head
16 Y-frame bar or Y-part of XY-gantry
16a bar guide
17 X-frame bar or X-part of XY-gantry
18 support platform or Z-part of XYZ-gantry
18a first conveyor roller
18b second conveyor roller
19 endless conveyor belt
20 support unit of Z-part of XYZ-gantry
20′ another support unit of Z-part of XYZ-gantry
20a support roller of support unit of Z-part of XYZ-gantry
21 heating means or suction means
22 cone shape of material printing nozzle of printing head
22a vertex angle 4)
23 inclination angle setting means
24 support flange of XY-gantry 16-17
25 three dimensional work piece
25′ another three dimensional work piece
26 support flange of support platform 18
27 fixating pin of setting means
30 pivot point
50 slices
250 imaginary work piece

1. A gantry-type three dimensional printing apparatus for printing a three dimensional work piece in a layer wise manner using a building material, said apparatus comprising:
a frame with an XYZ-gantry;
a printing head unit coupled to said XYZ-gantry;
a building material supply unit for feeding building material to said printing head unit; and
a support platform on which said three dimensional work piece is being printed in layers, said support platform being part of said XYZ-gantry and is movable in the Z-direction, wherein the support platform comprises an endless conveyor belt oriented parallel with horizontal, and wherein
the printing head unit is movable within a XY-plane being inclined relative to the Z-direction.

2. The gantry-type three dimensional printing apparatus according to claim 1, further comprising setting means for setting the angle of inclination of the XY-plane relative to the Z-direction.

3. The gantry-type three dimensional printing apparatus according to claim 1, wherein the angle of inclination between the XY-gantry and the Z-direction of the gantry formed by the support platform is adjustable at an angle range between 1° and 89°.

4. The gantry-type three dimensional printing apparatus according to claim 1, wherein the conveyor belt is made from a fiber composite cloth.

5. The gantry-type three dimensional printing apparatus according to claim 4, wherein said fiber composite cloth is impregnated with an epoxy resin.

6. The gantry-type three dimensional printing apparatus according to claim 1, wherein the conveyor belt is made from a metal sheet.

7. The gantry-type three dimensional printing apparatus according to claim 6, wherein the metal conveyor belt is made from a metal alloy with a low thermal expansion, or a plastic with a high thermal resistance.

8. The gantry-type three dimensional printing apparatus according to claim 4, wherein the conveyor belt is provided with a non-permanent adhesive coating.

9. The gantry-type three dimensional printing apparatus according to claim 1, wherein said support platform furthermore comprises suction elements for creating a vacuum or under pressure between the support platform and the three dimensional work piece to be printed.

10. The gantry-type three dimensional printing apparatus according to claim 1, wherein said support platform furthermore comprises heating elements disposed in the Z-direction for heating the endless conveyor belt.

11. The gantry-type three dimensional printing apparatus according to claim 1, wherein said support platform furthermore comprises cooling elements disposed in the Z-direction for cooling the endless conveyor belt.

12. The gantry-type three dimensional printing apparatus according to claim 11, wherein said cooling means comprises one or more cooling fans being disposed above the support platform and being directed towards the product being printed on the support platform.

13. The gantry-type three dimensional printing apparatus according to claim 1, wherein the printing head unit comprises a nozzle having a cone configuration, with a nozzle outlet positioned at an apex of the cone.

14. The gantry-type three dimensional printing apparatus according to claim 13, wherein the apex of the cone has a vertex angle ψ, where ½ψ(γ)<maximum angle β of inclination of the XY-plane relative to the Z-direction.

15. The gantry-type three dimensional printing apparatus according to claim 1, wherein the angle of inclination between the XY-gantry and the Z-direction of the gantry formed by the support platform is adjustable at an angle range between 15° and 50°.
